(19) United States
(12) Patent Application Publication
(10) Pub. No.: US 2024/0298195 A1
(43) Pub. Date: Sep. 5, 2024

(54) STEM-LIKE PLATFORM STATION

(71) Applicant: SOLUTIONS HUMANITAS INC., Montreal (CA)

(72) Inventors: Abdo SHABAH, Montreal (CA); Maroua BEN ATTIA, Montreal (CA); Chuan PHAM, Montreal (CA)

(21) Appl. No.: 18/594,889

(22) Filed: Mar. 4, 2024

Related U.S. Application Data
(60) Provisional application No. 63/449,805, filed on Mar. 3, 2023.

(51) Int. Cl. H04W 24/02; H04W 48/16; H04W 84/06

(52) U.S. Cl. CPC H04W 24/02; H04W 48/16; H04W 84/06

(57) ABSTRACT

A platform station comprises a sensors module configured to discover one or more surrounding network nodes and a motorized positioning system for maintaining a target position in an environment in comparison to the network nodes. The platform station includes a telecommunications module comprising an antenna management module configured to enhance antenna alignment of one or more antennas considering the network nodes and a configurable deployment module configured to selectively deploy one or more networking functionalities. The platform station comprises a collaborative dispatch module configured to set the target position considering a dispatch requirement settings and logically combine with at least one of the network nodes before selectively deploying the networking functionalities, while logically combined, based on the dispatch requirement settings. The platform station comprises an energy management mechanism configured to participate in energy exchange with at least one of the network nodes while the networking functionalities is uninterruptedly deployed.

### CROSS-REFERENCE TO RELATED APPLICATION

This non-provisional patent application claims priority based upon the prior U.S provisional patent application entitled “STEM-LIKE PLATFORM STATION”, application No. 63/449,805, filed 2023 Mar. 3, in the name of Solutions Humanitas Inc., which is herein incorporated by reference in its entirety.

### TECHNICAL FIELD

The present invention relates to a deployable telecommunication platform station.

### BACKGROUND

Deploying a telecommunications network from the ground up or complementing an existing telecommunications network is a complex task that typically requires multiple different network nodes.

The present solution aims at diminishing that complexity.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In some aspects, the techniques described herein relate to a platform station including: a sensors module configured to discover one or more surrounding network nodes; a motorized positioning system for maintaining a target position in an environment in comparison to the one or more surrounding network nodes; a telecommunications module including: an antenna management module configured to enhance antenna alignment of one or more antennas considering the one or more surrounding network nodes; a configurable deployment module configured to selectively deploy one or more networking functionalities; a collaborative dispatch module configured to: set the target position considering a dispatch requirement settings; and logically combine with at least one of the one or more surrounding network nodes before selectively deploying the one or more networking functionalities, while logically combined, based on the dispatch requirement settings; and an energy management mechanism configured to participate in energy exchange with at least one of the surrounding network nodes while the one or more networking functionalities is uninterruptedly deployed.

In some aspects, the techniques described herein relate to a platform station wherein the surrounding network nodes are transmitting or receiving platform stations.

In some aspects, the techniques described herein relate to a platform station wherein the sensors module is further configured to discover one or more source of power beaming.

In some aspects, the techniques described herein relate to a platform station wherein the energy management mechanism includes a signal-based energy exchange system such as a laser-based energy exchange system.

In some aspects, the techniques described herein relate to a platform station wherein the energy management mechanism includes a battery loading and unloading mechanism.

In some aspects, the techniques described herein relate to a platform station wherein the energy management mechanism comprises a photovoltaic receiver.

In some aspects, the techniques described herein relate to a platform, wherein the antenna management module physically modifies alignment of the one or more antennas.

In some aspects, the techniques described herein relate to a platform, wherein the antenna management module affects beam forming of the one or more antennas.

In some aspects, the techniques described herein relate to a platform, wherein the environment is defined as an aerial deployment environment.

In some aspects, the techniques described herein relate to a platform, wherein the environment is defined as a terrestrial deployment environment.

In some aspects, the techniques described herein relate to a platform, wherein the environment is defined as a hybrid terrestrial and aerial deployment environment.

In some aspects, the techniques described herein relate to a platform, wherein the dispatch requirement settings are received from a remote controller.

In some aspects, the techniques described herein relate to a platform, wherein the dispatch requirement settings are computed considering spectrum readings from the sensors module.

### BRIEF DESCRIPTION OF THE DRAWINGS

Further features and exemplary advantages of the present invention will become apparent from the following detailed description, taken in conjunction with the appended drawings, in which:

FIG. 1 is a logical modular representation of an exemplary network node deployed in a system in accordance with the teachings of the present invention;

FIG. 2 is a flow chart of an exemplary method in accordance with the teachings of the present invention; and

FIG. 3 is a logical modular representation of a network infrastructure compatible with the teachings of the present invention.

### DETAILED DESCRIPTION

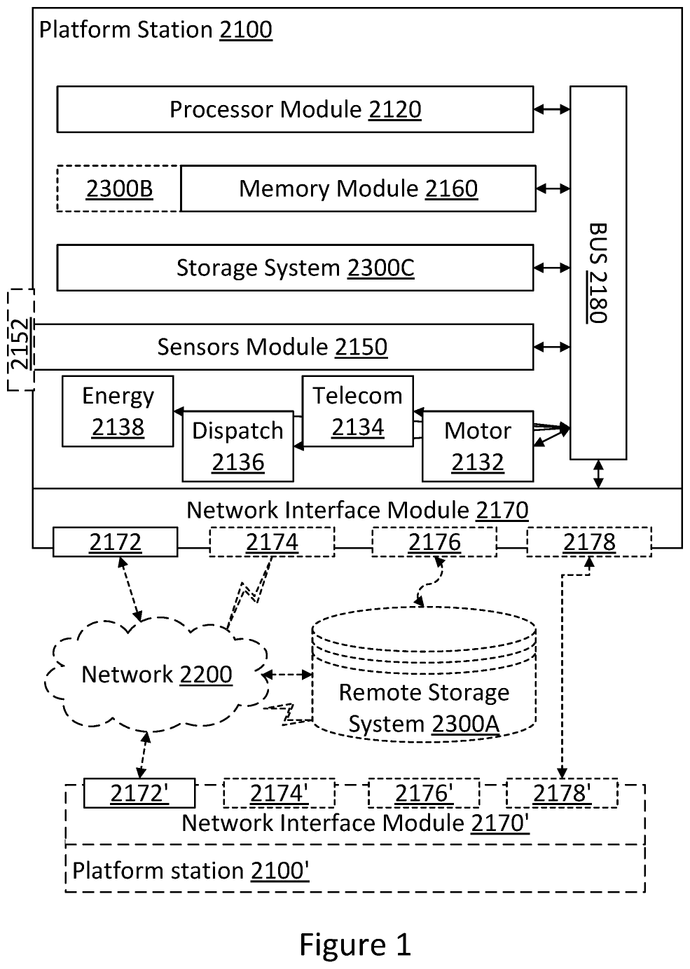

Reference is now made to the drawings in which FIG. 1 shows a logical modular representation of an exemplary system 2000 comprising a platform station 2100. The platform station 2100 comprises a memory module 2160, a processor module 2120, a telecommunications module 2134 and a network interface module 2170. The platform station 2100 may also include a sensors module 2150.

The system 2000 may comprise a storage system 2300 for storing and accessing long-term (i.e., non-transitory) data and may further log data while the platform station 2100 is being used. FIG. 1 shows examples of the storage system 2300 as a distinct database system 2300A, a distinct module 2300C of the platform station 2100 or a sub-module 2300B of the memory module 2160 of the platform station 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the platform station 2100 by a standardized or proprietary interface or via the network interface module 2170.

The network interface module 2170 represents at least one physical interface that can be used to communicate with other network nodes. The network interface module 2170 may be made visible to the other modules of the platform station 2100 through one or more logical interfaces. The actual stacks of protocols used by the physical network interface(s) and/or logical network interface(s) 2172-2178 of the network interface module 2170 do not affect the teachings of the present invention.

The processor module 2120 may represent a single processor with one or more processor cores or an array of processors, each comprising one or more processor cores. The memory module 2160 may comprise various types of memory (different standardized or kinds of Random Access Memory (RAM) modules, memory cards, Read-Only Memory (ROM) modules, programmable ROM, etc.).

A bus 2180 is depicted as an example of means for exchanging data between the different modules of the platform station 2100. The teachings presented herein are not affected by the way the different modules exchange information. For instance, the memory module 2160 and the processor module 2120 could be connected by a parallel bus, but could also be connected by a serial connection or involve an intermediate module (not shown) without affecting the teachings of the present invention.

A motorized positioning system 2132 provides services related to a physical special mobility (e.g., on the ground or in air) for the platform station 2100, which will be described in more details hereinbelow.

A telecommunications module 2134 provides telecommunications-related services to the platform station 2100. The telecommunications module 2134 may also further comprise an antenna management module configured to enhance antenna alignment of one or more antennas considering the one or more surrounding platform stations and a configurable deployment module configured to selectively deploy one or more networking functionalities, which will be described in more details hereinbelow. In some instances where the platform station 2100 is a flying vehicle in a system for harvesting energy while fluing for usage by neighboring network nodes and/or ground usage, the telecommunications module 2134 may be used to exchange information with neighboring network nodes for positioning and movement management purposes.

A collaborative dispatch module 2136 provides services related to a deployment or dispatch request for the platform station 2100, which will be described in more details hereinbelow.

An energy management mechanism 2138 provides energy-related services to the platform station 2100, which will be described in more details hereinbelow.

The variants of processor module 2120, memory module 2160 and network interface module 2170 usable in the context of the present invention will be readily apparent to persons skilled in the art. Likewise, even though explicit mentions of the telecommunications module 2134, the memory module 2160, the sensors module 2150 and/or the processor module 2120 are not made throughout the description of the present examples, persons skilled in the art will readily recognize when such modules are used in conjunction with other modules of the platform station 2100 to perform routine as well as innovative elements presented herein.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

The sensors module 2150 is configured to discover one or more surrounding platform stations. The sensors module 2150 may be equip, for instance of: Radio frequency (RF) sensors. The platform station 2100 may use the sensors to detect other platform stations (e.g., HAPs or UAVs) therearound. RF sensors may further detect signals from other devices that are transmitting on a specific frequency or set of frequencies and can use the strength of the signal to estimate the distance to the other device.

The sensors module 2150 may alternatively or additionally further comprise LiDAR sensors. LiDAR (Light Detection and Ranging) sensors lasers may be used to measure the distance to objects in their vicinity. A platform station 2100 equipped with LiDAR sensors may scan the surrounding space (e.g., airspace for other HAPs or UAVs), and estimate their distance and location based on the reflected laser light.

The sensors module 2150 may alternatively or additionally further comprise Visual sensors, A platform station 2100 may use one or more cameras or other visual sensors to detect other platform stations (e.g., HAPs or UAVs in its vicinity). Visual sensors may further capture images or video of the surrounding space (e.g., airspace) and identify other devices based on their size, shape, or markings.

The sensors module 2150 may alternatively or additionally further use, directly or indirectly, communication technologies. For instance, a platform station 2100 may use communication technologies such as Wi-Fi, Bluetooth to detect other HAPs or UAVs in its vicinity. By scanning for nearby devices using communication technologies, a platform station 2100 can estimate the distance and location of other devices and potentially establish a connection for communication.

The motorized positioning system 2132 is used for maintaining a target position in an environment in comparison to the one or more surrounding platform stations.

A combination of GPS data and sensors (e.g., visual) may be used to determine the platform station location relative to the surrounding platform stations. The motorized positioning system 2132 may then adjust the platform station's 2100 position as necessary to maintain the target position. Visual sensors may also be used to capture images or video of the surrounding environment and identify the platform stations based on visual characteristics thereof (size, shape, or markings). The GPS data may then provide the platform station's 2100 current location and orientation relative to the surrounding platform stations.

The motorized positioning system 2132 may use motors or actuators to adjust the platform station position and/or orientation. In the case of a flying platform station 2100, such adjustment may take the form of adjusting the angle of wings or using thrusters to move in a specific direction. The motorized positioning system 2132 may further be programmed to continuously monitor the platform station's 2100 position relative to the target position and make adjustments as necessary to maintain the target position.

In some embodiments, the surrounding platform stations themselves may be equipped with sensors and communication technologies that enable them to transmit location and orientation data to the platform station 2100, allowing a more accurately determination of a current position and make more precise adjustments relative to the target position.

The antenna management module of the telecommunications module 2134 may be configured to enhance antenna alignment of one or more antennas considering the one or more surrounding platform stations.

Combining a programmable antennas management software and the motorized positioning system 2132 may allow for adjusting the alignment of the antennas based on the platform station 2100 position and orientation relative to the surrounding platform stations. The programmable antennas management software may aggregate data from GPS, sensors (e.g., visual), and communication systems to determine the platform station 2100 location and orientation, as well as the location and orientation of the surrounding platform stations.

The motorized positioning system 2132 may then adjust the alignment of the antennas based on aggregated data, aiming at an optimal antenna alignment in order to maximize signal strength and quality. The motorized positioning system 2132 may use motors or actuators to adjust the orientation and angle of the antennas independently of other systems of the platform station 2100, thereby allowing for precise alignment even in changing environmental conditions.

In addition, the antenna management module may be programmed to continuously monitor the signal strength and quality, and make adjustments as necessary to maintain optimal antenna alignment. Such continuous monitoring aims at minimizing signal interference and ensure reliable and high-quality communication in a system deploying multiple platform station systems. Coordinating antennas is also called “antenna array processing” where multiple antennas are placed on the platform station 2100, typically arranged in a regular pattern (e.g., a linear or circular array). The signals from each antenna are combined using a signal processing algorithm, such as beamforming, spatial filtering, or diversity combining. The combined signal is transmitted to the ground station or receiver, where it is demodulated and decoded. By using multiple antennas and combining their signals, antenna array processing can provide several benefits: Increased signal strength, improved signal quality, increased reliability.

The configurable deployment module of the telecommunications module 2134 may be configured to selectively deploy one or more networking functionalities.

A stem-cell node is equipped on the platform station 2100 to enable a zero-touch network in which a 5G functional split architecture on multiple platform stations is deployed. A stem-cell node on the platform station may be made to be compatible with the O-RAN specifications, including the necessary radio hardware and interfaces. Stem-cell software stack includes various O-RAN components such as the O-RAN controller, radio resource manager, radio unit (RU), distributed unit (DU), centralized unit (CU), the stem-cell orchestration layer.

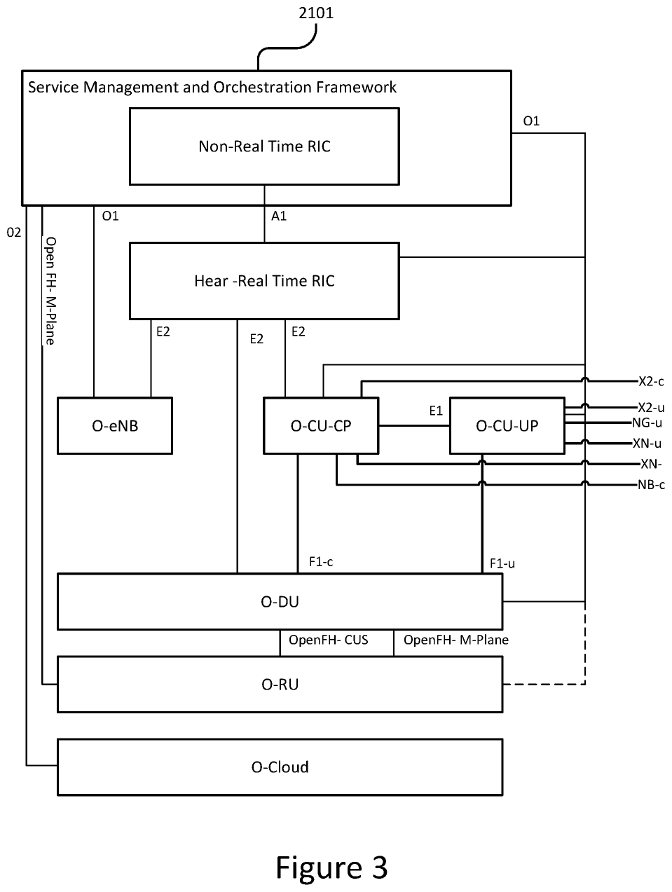

Once the platform station 2100 and surrounding stations are enabled for stem-cell network, the platform stations are able to communicate and operate together. Configuring the network connectivity between the platform stations would be required. An example of supported configuration is depicted on FIG. 3. O-RAN specifications define various interfaces and protocols for communication between the O-RAN components, including the O1 interface between the O-RAN controller and radio resource manager, the O2 interface between the radio resource manager and distributed unit, and the E2 interface between the distributed units. To manage the O-RAN network of HAPs, an orchestration system is implemented to monitor and control the platform stations. Software may be deployed that can manage the O-RAN components on the platform stations, as well as the network connectivity therebetween. The O-RAN specifications define various management and control plane protocols, including the A1 interface for network management and the A2 interface for radio resource management.

Interoperability testing would advantageously be performed to ensure that the stem-cell on platform stations is compatible with other vendors' O-RAN components and compliant with the O-RAN specifications.

The collaborative dispatch module 2136 is configured to set the target position considering dispatch requirement settings. Once the dispatch requirement settings are received, the collaborative dispatch module 2136 on platform station 2100 may calculate one positioning scenario in which a target position is set for each of the collaborative platform stations. For instance, the positioning scenario may be optimized based on the prioritization criteria (e.g., critical coverage areas and/or density, etc.). The target position may then be sent to the individual platform stations. The platform stations can then adjust their path and attitude (e.g., flight path and altitude) to reach the target position as efficiently as possible.

To ensure as close as real-time communication and coordination among the platform stations and the control system, a reliable and low-latency communication network may be provided, using a dedicated satellite communication network or a 5G mobile network. Such a dedicated network may help ensure that the collaborative dispatch module 2136 is able to respond quickly to changing dispatch requirements and enable safe and efficient dispatch operations.

The collaborative dispatch module 2136 also logically combines the platform station 2100 with at least one of the one or more surrounding platform stations before selectively deploying the one or more networking functionalities, while logically combined, based on the dispatch requirement settings.

For instance, each platform station may be equipped with a collaborative dispatch module allowing communication with other neighboring platform stations to coordinate the deployment of networking functionalities based on dispatch requirements. The collaborative dispatch module 2136 may prioritize the dispatch requirements based on various factors, such as the urgency of the dispatch, the network bandwidth requirements, and the available resources on each platform station.

Before selectively deploying the networking functionalities, the collaborative dispatch module 2136 may logically combine the platform station 2100 with at least one of the one or more surrounding platform stations to ensure that the combined resources are sufficient to meet the dispatch requirements. The collaborative dispatch module 2136 may then selectively deploy the required networking functionalities based on the prioritization criteria and available resources on the combined platform stations.

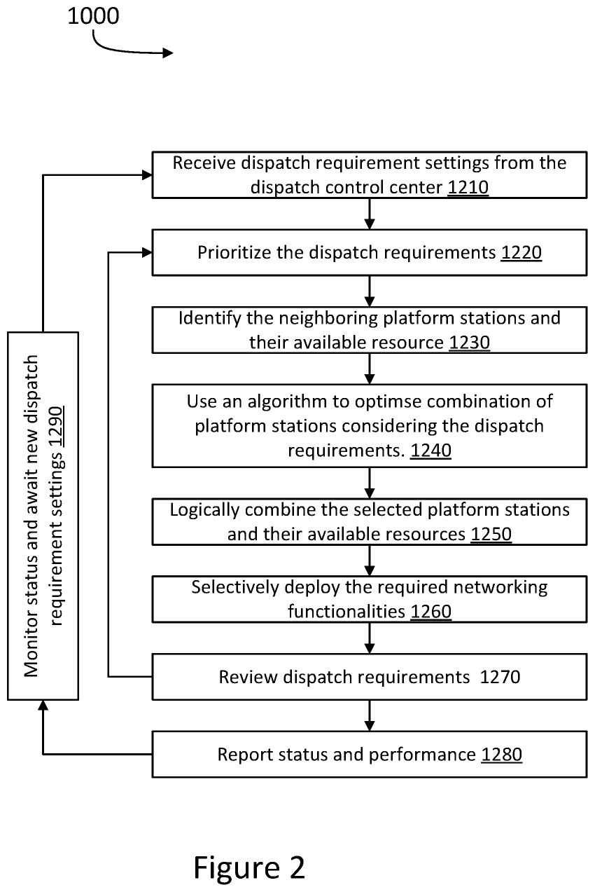

FIG. 2 provides an example of response to dispatch requirements. The method 1000 comprises receiving 1210 dispatch requirement settings (e.g., from a dispatch control center). The method continues with prioritizing 1220 the dispatch requirements based on various factors, such as the urgency of the dispatch, the network bandwidth requirements, and the available resources on each platform station. The neighboring platform stations and their available resources, such as network bandwidth, processing power, and storage capacity are then identified 1230. An algorithm may then be sued to determine 2140 an optimal combination of platform stations that can meet the dispatch requirements. Logically combining 1250 the selected platform stations and their available resources to form a virtual network follows. The method then continues with selectively deploying 1260 the required networking functionalities on the combined platform stations based on the prioritization criteria and available resources on the virtual network. Following deployment 1260, monitoring and review 1270 of the status of the virtual network may be performed to allow adjusting the deployment of networking functionalities as needed to ensure optimal performance. The method may also include report 1280 the status and performance of the virtual network to the dispatch center and other relevant parties. Each new dispatch requirement settings received would trigger 1290 the method 1000 again.

The energy management mechanism 2138 is configured to participate in energy exchange with at least one of the surrounding platform stations while the one or more networking functionalities is uninterruptedly deployed.

For instance, the platform station 2100 may be equipped with an energy management system that can communicate with other neighboring platform stations to coordinate energy exchange. The energy management mechanism 2138 can monitor the energy consumption and generation of each platform station and use an algorithm to determine the optimal energy exchange strategy based on the energy needs and available resources of each station.

When a platform station needs additional energy, a request for energy may be mad towards neighboring stations that may have excess energy. Similarly, when a platform station has excess energy, an energy offer may be made to neighboring stations. Such a mechanism may ensure that the platform stations have a stable and reliable source of energy while minimizing waste and reducing dependence on external energy sources.

When deployed the dedicated satellite communication network or the 5G mobile network may also ensure that the energy management mechanism 2138 is able to respond quickly to changing energy needs and enable safe and efficient energy exchange.

Additionally, to ensure the uninterrupted deployment of networking functionalities during energy exchange, the energy management mechanism 2138 may prioritize the energy needs of the platform stations based on the criticality of the deployed networking functionalities. For example, the energy needs of a platform station that is hosting a critical networking function, such as emergency communication, can be prioritized over other less critical functions, thereby ensuring that the platform stations are able to maintain uninterrupted networking services while participating in energy exchange.

There are some potential protocols that can be used for energy exchange in platform stations, depending on the specific requirements and constraints of the system.

IEEE 802.11 is a widely used standard for wireless local area networks (WLANs), which can be adapted for energy exchange in platform stations. The protocol can be used for communication between the energy management system and the platform stations to coordinate energy exchange.

IEEE 802.15.4 is a low-power wireless protocol that is commonly used in Internet of Things (IoT) applications. The protocol can be used for communication between the energy management system and the platform stations, especially for low-power communication.

IEC 61850 is a standard protocol for communication in power systems. The protocol can be used for communication between the energy management system and the platform stations to exchange energy and monitor energy status.

OpenADR is an open standard for demand response in energy management systems. The protocol can be used to coordinate energy exchange between the energy management system and the platform stations, especially for demand response scenarios.

MQTT is a lightweight messaging protocol that is commonly used in IoT applications. The protocol can be used for communication between the energy management system and the platform stations to exchange energy status and control energy flow.

OPC UA is a standard protocol for industrial communication and can be used for energy exchange in HAPs. The protocol can be used for communication between the energy management system and the platform stations to exchange energy and monitor energy status.

The platform station 2100 may, in certain embodiments, use a laser-based energy exchange system as part of the energy management mechanism 2138. Energy is transferred between the platform station 2100 and a ground station using technologies such as microwave power transmission or laser power transmission and/or between different platform stations and/or between a dedicated energy station (e.g., equivalent to a flying tanker) and the platform station 2100. The energy management mechanism 2138 can monitor the energy levels of the HAPs and initiate the transfer process when necessary.

The energy management mechanism 2138 may also, additionally or alternatively, comprise a battery loading and unloading mechanism, which involves physically replacing one or more depleted batteries in the platform station 2100 with fully charged ones. The energy management mechanism 2138 may monitor the energy levels of the batteries and initiate the swapping process when necessary. The swapped batteries can then be recharged on the ground and used again in other platform stations.

The antenna management module may physically modify alignment of the one or more antennas. For instance, steerable antennas may be deployed that can be electronically adjusted to change their direction and alignment. The antenna management module can monitor the network and signal conditions and adjust the antennas accordingly to optimize the signal quality and coverage. Gimbal systems may alternatively or additionally be deployed to physically adjust the orientation and alignment of the antennas. The antenna management module can control the gimbal systems to modify the alignment of the antennas as needed to optimize the signal quality and coverage. In additional or alternatively, robotic systems may be deployed that physically move the antennas to change their alignment. The antenna management module can control the robotic systems to modify the alignment of the antennas as needed to optimize the signal quality and coverage. In the case of flying platform stations, aerodynamic designs may additionally or alternatively be deployed. The platform station 2100 may be designed with aerodynamic features that allow them to adjust their orientation and alignment in response to environmental conditions such as wind or turbulence. The antenna management module can monitor the network and signal conditions and adjust the orientation and alignment of the HAPs to optimize the signal quality and coverage.

The antenna management module may optionally affect beam forming of the one or more antennas. These are examples of mechanism, which are based on beam forming. Adaptive beamforming: the platform station 2100 can be equipped with adaptive beamforming capabilities that can dynamically adjust the direction and shape of the antenna beams to optimize signal quality and coverage. The antenna management module can monitor the network and signal conditions and adjust the beamforming parameters to optimize the signal quality and coverage. Multiple Antennas: the platform station 2100 can be equipped with multiple antennas that can be configured to transmit and receive signals in different directions. The antenna management module can control the selection and activation of the antennas to optimize the signal quality and coverage. Hybrid Beamforming: the platform station 2100 can be equipped with hybrid beamforming capabilities that combine the advantages of analog and digital beamforming to optimize the signal quality and coverage. The antenna management module can control the selection and activation of the analog and digital beamforming parameters to optimize the signal quality and coverage. Intelligent Antenna Systems: the platform station 2100 can be equipped with intelligent antenna systems that use advanced algorithms and artificial intelligence techniques to optimize the signal quality and coverage. The antenna management module can control the selection and activation of the intelligent antenna systems to optimize the signal quality and coverage. Distributed antennas on the platform station 2100: the antennas may be connected to a central processing unit via the network interface module 2170. The central processing unit can process and distribute the signals from the antennas to improve the signal quality and coverage. In a platform station-based DAS, the distributed antennas may be located on the platform station 2100 or on other platforms that are connected to the platform station 2100. The platform station 2100 can function as a central processing unit that can process and distribute the signals from the distributed antennas to optimize the signal quality and coverage.

The platform station 2100 may be deployed in an environment defined as an aerial deployment environment. The platform station 2100 may be a High-Altitude Platform (HAP) that uses unmanned aerial vehicles or balloons to provide wireless communication services or other functions from high altitudes. HAP technology has the capability to communicate with other flying units such as satellites, UAVs, and drones at different altitudes. Advanced communication technologies may be used for that purpose, such as millimeter wave (mmWave), Long-Term Evolution (LTE), and 5G networks, which allow for high-bandwidth communication between the HAP platform and other aerial units.

The HAP platform's ability to provide wireless communication services to other aerial units can be particularly useful in areas where traditional ground-based communication infrastructure is limited or non-existent. Additionally, the HAP platform can be used for a variety of applications, including surveillance, environmental monitoring, and disaster response. The platform's aerial deployment environment allows for flexible and efficient deployment, making it a versatile technology with a wide range of potential use cases

The platform station 2100 may be deployed in an environment defined as a terrestrial deployment environment. Similarly, manned or unmanned vehicles may be deployed geographically to provide wireless communication services or other functions.

The platform station 2100 may also be deployed in an environment defined as a hybrid terrestrial and aerial deployment environment.

The dispatch requirement settings may be received from a remote controller. The term “dispatch requirement settings” refers to specific instructions or settings that are required for the platform station 2100 to perform a particular function or task. Particularly, if the platform station 2100 is being used for wireless communication services, the dispatch requirement settings include the frequency range to be used, the bandwidth allocation, and other parameters that are necessary for effective communication.

In order for the platform station 2100 to receive these dispatch requirement settings, the network interface module 2170 may be designed to communicate with a remote controller. The remote controller is typically a device or system that is located outside of the platform station 2100, such as a ground-based control station or a satellite-based command center or even on another platform station. The remote controller sends the dispatch requirement settings to the platform station 2100 via a communication link, which could be a wireless link or a wired link, depending on the specific system. In the network of the platform station 2100, the stem-cell-based solution enables a zero-touch procedure to establish an ad hoc network to cluster multiple platform stations together and/or with other flying units and then automatically select a controller node to manage the cluster.

Once the platform station 2100 receives the dispatch requirement settings, the receive data may be used to perform the desired function or task. For example, when the platform station 2100 is being used for wireless communication services, it will use the dispatch requirement settings to configure its transmitters and receivers to communicate on the correct frequency range and with the correct parameters.

The dispatch requirement settings may alternatively or additionally be computed considering spectrum readings from the sensors module 2150. The sensors module 2150 may be designed to measure the spectrum of the surrounding electromagnetic environment. The sensors module 2150 may include sensors such as radio frequency (RF) receivers, spectrum analyzers, and other equipment that can detect and analyze the characteristics of the electromagnetic waves in the area. When the platform station 2100 receives dispatch requirement settings from a remote controller, information from the sensors module 2150 may be used to compute the optimal settings for the specific environment in which it is operating. By analyzing the spectrum readings from the sensors module 2150, the platform station 2100 can determine the available frequency bands, the level of interference, and other factors that may affect the quality of its wireless communication or other functions.

Based on the analysis, the platform station 2100 may compute the dispatch requirement settings that are best suited for the specific environment in which it is operating. For example, when the sensors module 2150 detects a high level of interference in a particular frequency band, the platform station 2100 may compute dispatch requirement settings that use a different frequency band or that employ advanced interference mitigation techniques.

The ability of the platform station 2100 to compute dispatch requirement settings based on spectrum readings from the sensors module 2150 may be key for enabling autonomous adaptation to different environments and operating conditions. By dynamically adjusting its settings based on real-time sensor data, the platform station 2100 can optimize its performance and ensure reliable and effective operation.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A platform station comprising:
a sensors module configured to discover one or more surrounding network nodes;
a motorized positioning system for maintaining a target position in an environment in comparison to the one or more surrounding network nodes;
a telecommunications module comprising:
an antenna management module configured to enhance antenna alignment of one or more antennas considering the one or more surrounding network nodes;
a configurable deployment module configured to selectively deploy one or more networking functionalities;
a collaborative dispatch module configured to:
set the target position considering a dispatch requirement settings; and
logically combine with at least one of the one or more surrounding network nodes before selectively deploying the one or more networking functionalities, while logically combined, based on the dispatch requirement settings; and
an energy management mechanism configured to participate in energy exchange with at least one of the surrounding platform stations while the one or more networking functionalities is uninterruptedly deployed.

2. The platform station of claim 1, wherein the surrounding network nodes are transmitting or receiving platform stations.

3. The platform station of claim 1, wherein the energy management mechanism comprises a signal-based energy exchange system such as a laser-based energy exchange system.

4. The platform station of claim 1, wherein the energy management mechanism comprises a battery loading and unloading mechanism.

5. The platform station of claim 1, wherein the energy management mechanism comprises a photovoltaic receiver.

6. The platform station of claim 1, wherein the antenna management module physically modifies alignment of the one or more antennas.

7. The platform station of claim 1, wherein the antenna management module affects beam forming of the one or more antennas.

8. The platform station of claim 1, wherein the environment is defined as an aerial deployment environment, as a terrestrial deployment environment or as a hybrid terrestrial and aerial deployment environment.

9. The platform station of claim 1, wherein the dispatch requirement settings is received from a remote controller.

10. The platform station of claim 1, wherein the dispatch requirement settings is computed considering spectrum readings from the sensors module.

11. The platform station of claim 1, wherein the sensors module is further configured to discover one or more source of power beaming.
